(19) United States
(12) Patent Application Publication
(10) Pub. No.: US 2011/0047188 A1
(43) Pub. Date: Feb. 24, 2011

(54) Method and System for Automatic Tracking of Information Technology Components and Corresponding Power Outlets in a Data Center

(76) Inventors: Carios Martins, Fremont, CA (US); Nei Chiaradia, Pleasanton, CA (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 12/546,514

(22) Filed: Aug. 24, 2009

(51) Int. Cl. G06F 17/30

(52) U.S. Cl. 707/803; 707/E17.005

(57) ABSTRACT

Methods and systems provide the automatic tracking and management of information technology components and their corresponding power supplies. These systems automatically identify when a given IT component, such as a server, router, switch or other device, is connected or disconnected from a particular power outlet. When a server is connected or disconnected from a particular power outlet, the tracking database is automatically updated, and users of the database have instantaneously accurate information about which IT components are plugged into each power outlet in a data center. If the server is changed to a different outlet, the system immediately identifies that the given server or device is connected to a different outlet. Users can rely on the information in the database when remotely managing the power supplies of the data center's IT assets.

### RELATED APPLICATION

This patent application is related to U.S. patent application Ser. No. ______, entitled “Method and System for Automatic Location Tracking of Information Technology Components in a Data Center” which is incorporated herein by reference.

### FIELD OF THE INVENTION

This generally relates to information technology components in a data center, and more particularly to automatic tracking of information technology components, such as servers, and their corresponding power outlets in a data center.

### BACKGROUND

Data centers are buildings or rooms that house large numbers of information technology components such as servers, data processors, switches, routers, network equipment or other computer components. Typically, the interior of a data center is filled with multiple rows of cabinet-like equipment called racks that are arranged in parallel to one another throughout the data center. Each rack houses multiple, vertically spaced components, and an aisle for service personnel is often provided between rows of racks. In this way, a large number of servers or other components can be placed in a data center.

The individual information technology (IT) components mounted inside the racks are supplied power by power distribution units (PDU) that typically mount to the rear columns of the rack. A PDU is a device that distributes electric power, typically for use in these data centers, and may be a reliable, multiple outlet power strip designed to deliver conditioned power to networking, server or telecom equipment. PDU's comprise a plurality of electrical receptacles to which the electrical plugs of the various components can be coupled.

There are three main types of conventional PDU systems, a basic PDU, a metered PDU and a switched PDU, each with a graduated set of features. A basic PDU is primarily used to provide enough outlets to reliably power the many servers, networking and other electronic devices that require continuous power. A basic PDU offers simple but highly reliable power distribution to multiple pieces of equipment in a data center.

With a metered PDU, network managers can keep track of the amount of power their equipment is consuming to help determine when the time is right to add more electrical capacity or larger power supply systems to support a growing network. A metered PDU typically offers the same benefits of a basic PDU (e.g., multiple outlets, long input cord), plus the ability to monitor the total amount of current that flows through the PDU.

In a switched PDU, remote control of networking devices in a remote or secure environment is provided. A switched PDU offers the same benefits of a basic and metered PDU (e.g., multiple outlets, long input cord, metered power consumption), plus the ability to remotely power each outlet off and back on again, via an Ethernet network connection, for example. The main benefit of this arrangement is that equipment housed in a secure data center, server room, or locked enclosure can be powered off and on again remotely. This keeps network managers from having to travel to each location to manually power cycle equipment. Also, less critical equipment (such as monitors) can be manually powered down during a prolonged power outage so the most critical servers and networking equipment will run as long as possible from backup battery power.

When powering these technology components on and off remotely, data center technicians need to be sure that they are activating or deactivating the power for the right component. Sometimes during maintenance, data center technicians can unplug and/or remove a target component, move the component elsewhere within the data center, or change the power supply to the component. In these cases, if the database for tracking the location of these components is not updated, conventionally a manual process, the database will be outdated and contain inaccurate information. A technician's reliance on this incorrect information can be greatly detrimental, particularly pertaining to the powering on and off of these components remotely. For example, if a technician intends to power off target component X on outlet 10 of PDU 5, they could accidently power off target component Y instead.

Conventional solutions rely heavily on manual processes to control and update data regarding the power connection of these components to specific physical power outlets. Any changes in the infrastructure such as removing the power cord from one outlet and placing it in another are not detected immediately by conventional systems. In these systems, technicians are relied upon to notify the changes through proper communications, and a person manually updates the database. These processes are often violated through human error, leaving the database with incorrect information. As a result, conventional systems do not allow users to be sure that when remotely managing power of a given server or device the right server or device will be managed. Accordingly, it is desirable to have methods and systems to avoid these and other related problems.

### SUMMARY

In accordance with methods and systems consistent with the present invention, a method in a data processing system for automatically tracking associations of power outlets to IT components is provided comprising connecting one or more IT components to one or more power outlets. The method also comprises automatically identifying the one or more IT components connected to the one or more power outlets, and automatically identifying when one or more of the IT components are disconnected from one or more of the power outlets.

In accordance with methods and systems consistent with the present invention, a method in a data processing system for automatically tracking associations of power outlets to IT components is provided comprising connecting one or more IT components to one or more power outlets, and automatically identifying the one or more IT components connected to the one or more power outlets.

In one implementation, a power plug device in a data processing system for automatically tracking associations of power outlets to IT components is provided comprising a power plug configured to plug into the power outlet of a PDU, and a power outlet configured to accept a power plug from an IT component having an associated RFID tag uniquely identifying the IT component. The power plug device further comprises an RFID reader configured to receive an indication of an identification of the IT component from the RFID tag, and a processor configured to transmit the received identification.

In another implementation, a data processing system for automatically tracking associations of power outlets to IT components is provided comprising an IT component comprising an RFID tag configured to uniquely identify the IT component. The data processing system further comprises a power plug device comprising a power plug configured to plug into the power outlet of a PDU, and a power outlet configured to accept a power plug from the IT component. The power plug device also comprises an MD reader configured to receive an indication of an identification of the IT component from the RFID tag, and a processor configured to transmit the identification. The data processing system also comprises a PDU comprising at least one power outlet configured to accept the power plug from the device.

### BRIEF DESCRIPTION OF THE DRAWINGS

FIG. 1 illustrates an exemplary PDU, IPC, RFID reader and IT component in accordance methods and systems consistent with the present invention.

FIG. 2 illustrates steps in an exemplary associated method in accordance with systems consistent with the present invention.

FIG. 3 depicts an exemplary PDU, IPC, RFID reader, server and central point signal concentrator.

FIG. 4 illustrates steps in an exemplary associated method in accordance with systems consistent with the present invention.

FIG. 5 depicts an exemplary PDU, IPC, RFID reader and a central point signal concentrator signaling a request to an RFID reader.

FIG. 6 illustrates steps in an exemplary associated method in accordance with systems consistent with the present invention.

### DETAILED DESCRIPTION

Methods and systems in accordance with the present invention provide the automatic tracking and management of information technology components and their corresponding power supplies. These methods and systems automatically identify when a given IT component, such as a server, router, switch or other device, is connected or disconnected from a particular power outlet. When a server, for example, is connected or disconnected from a particular power outlet, the tracking database is automatically notified and updated, and users of the database have instantaneously accurate information about which IT components are plugged into each power outlet in a data center. If the server is changed to a different outlet, the system immediately identifies that the given server or device is connected to a different outlet. Users can confidently rely on the information in the database when remotely managing the power supplies of the data center's IT assets. These systems allow users to be sure that, when remotely managing power of a given server or device, the right server or device will be affected.

In one implementation, a hardware component, e.g., an “intelligent” power cord or strip (IPC), is inserted on the power supply between a PDU and a server, and this hardware component indicates to the system that the particular server is connected to the specific outlet on the PDU, even in light of various physical configuration changes that take place in the data center. As described further below, the system receives a unique ID from the server, for example, and automatically supplies this information to the database. During maintenance, a technician could remove the server's power cord from the outlet or change it to another outlet of a different PDU, and the other PDU would receive the identification information from the intelligent power cord, and pass the information upstream to a software layer and then to the database to be updated.

In one implementation, the identification of the connected IT component is performed using radio-frequency identification (RFID). RFID involves the use of a device, typically referred to as an RFID tag, applied to or incorporated into a product for identification and tracking using radio waves. Typical RFID tags contain at least two primary parts. One is an integrated circuit for storing and processing information, modulating and demodulating a radio-frequency (RF) signal, and other specialized functions. The second is an antenna for receiving and transmitting the signal. There are generally two types of RFID tags: active RFID tags, which contain a battery and can transmit signals autonomously, and passive RFID tags, which have no battery and use an external source to provoke signal transmission.

The hardware component, e.g., IPC, placed on the power supply between the server (or other IT component) and the PDU includes an RFID reader. This IPC (or other hardware component) is plugged into the PDU and has a power outlet that accepts the power plug of the server, which includes an RFID tag which uniquely identifies the server. In this way, power from the PDU flows through the IPC having the RFID reader to the server.

The IPC includes hardware and software for receiving, processing and outputting signals as described further below, and it may include a processor for performing these functions. The RFID reader reads the unique ID from the RFID tag on the server through wireless communication, and transmits the server's unique identification through one of many possible implementations. In one implementation, the IPC and RFID reader supplies the identification information through the power cord to the PDU via a protocol similar to Power Line Communication (PLC), which may be a simplified version of PLC. The PDU may then process the identification data to be sent to a software layer to be transferred to the data center's IT asset database.

In another implementation, the PDU sends a request for identification through the power cord to the IPC and RFID reader using a protocol similar to PLC. In addition to receiving this request, the RFID reader wirelessly receives the server ID from the server's RFID tag. The RFID reader sends the server's identification wirelessly to a central point, such as a signal concentrator, which may aggregate many different wireless signals from other RFID readers. The central point signal concentrator relays the identification information to the database for update.

In yet another implementation, the RFID reader receives a wireless request signal from the central point signal concentrator to identify the attached server. This request may originate from a user or the database requesting a status on a particular power outlet or PDU. In this case, the RFD reader reads the server's ID from its RFID tag and the IPC sends the identification to the PDU through a hardware signal, such as a pulse in a given pattern, through the power cord and outlet. The PDU detects those pulses which indicate the server's identification and identifies to which outlet the server is connected. The identification is then relayed to the database.

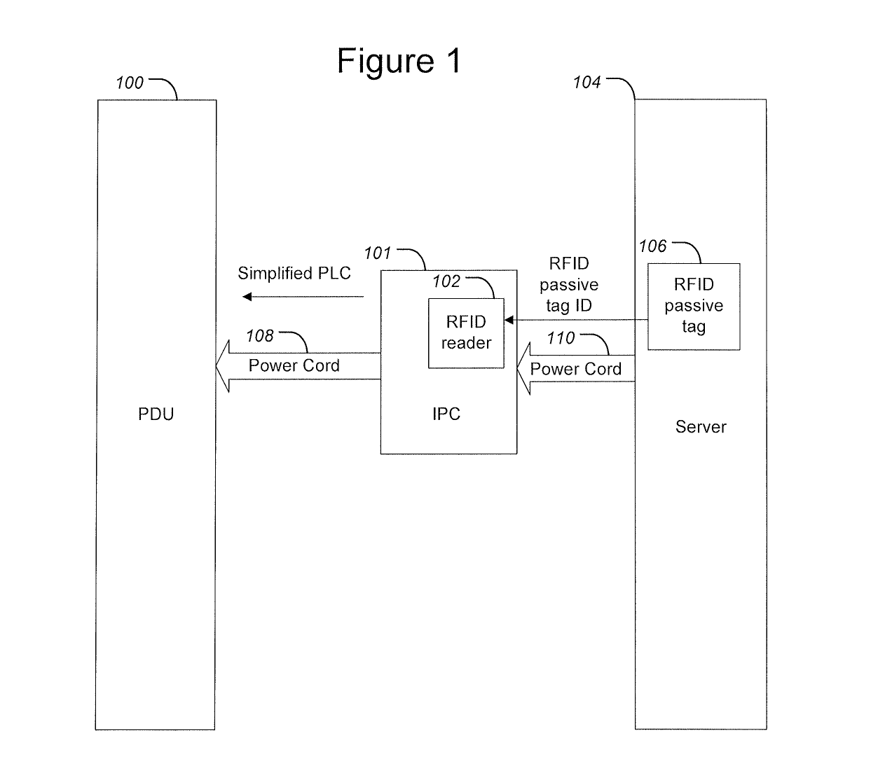

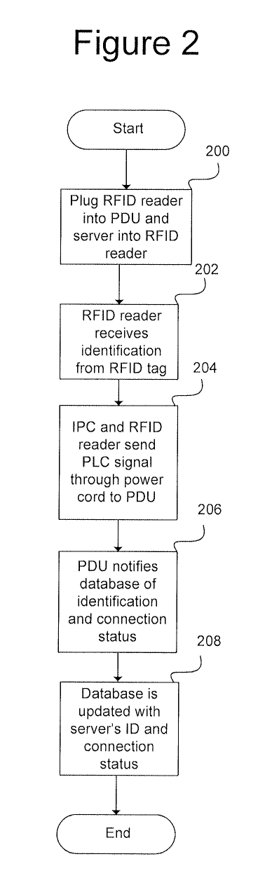

FIG. 1 illustrates an exemplary PDU 100, an IPC 101, an RFID reader 102 and an IT component, e.g., a server 104, in accordance methods and systems consistent with the present invention. FIG. 2 illustrates steps in an exemplary associated method in accordance with systems consistent with the present invention, and is discussed in conjunction with FIG. 1. First, the IPC 101 including the RFID reader 102 is plugged into the PDU's power outlet, and the server's power plug 110 is plugged into the power outlet on the IPC 101 (step 200).

The RFID reader 102 receives the RFID identification signal identifying the server 104 from the passive MD tag 106 attached to the server 104 (step 202). In one implementation, the RFID tag 106 is a passive tag, and is placed close to the power outlet on the RFID reader. This may avoid potential interference or confusion with other RFID tags on servers that may be nearby. In other implementations, the RFID tag 106 may be an active tag. The IPC 101 and RFID reader 102 then send the identification to the PDU 100 through the power cord 108 via a software signal protocol similar to PLC (step 204), or any other suitable protocol. This signal may indicate that the server 104 is now connected to a particular power outlet (not shown) of the PDU 100, and the system is aware of that connection. The PDU 100 may also include hardware and software to accept data received through the power cord 108 from the IPC 101. This hardware and software then processes the data before sending it to the software layer to be sent to the database.

In this case, the PDU 100 notifies the database (not shown) via a software layer (step 206). In one implementation, the PDU 100 connects to the database through an intermediate software layer. This software layer may include data center management software, such as DSView from Avocent, Inc, which may allow access to various IT components and PDU's and provide remote management and remote configuration. The PDU 100 may be connected to the DSView application through a network, or may be plugged into another appliance (e.g., via the serial port of an Avocent console server or KVM system) which is connected to the DSView through the network. The DSView may pass the information received from the PDU 100 to the database or other application that manages the IT components of the data center. However, other implementations are possible.

The database is updated with the server's ID and its connection to that particular power outlet on the PDU 100 (step 208). The IPC 101 and RFID reader 102 may also send a signal with the server's ID to the PDU 100 to indicate a disconnection when the server 104 is disconnected. Although not shown on the figure, many other servers or other IT components may be connected to various power outlets of PDU 100 or other PDU's in the system.

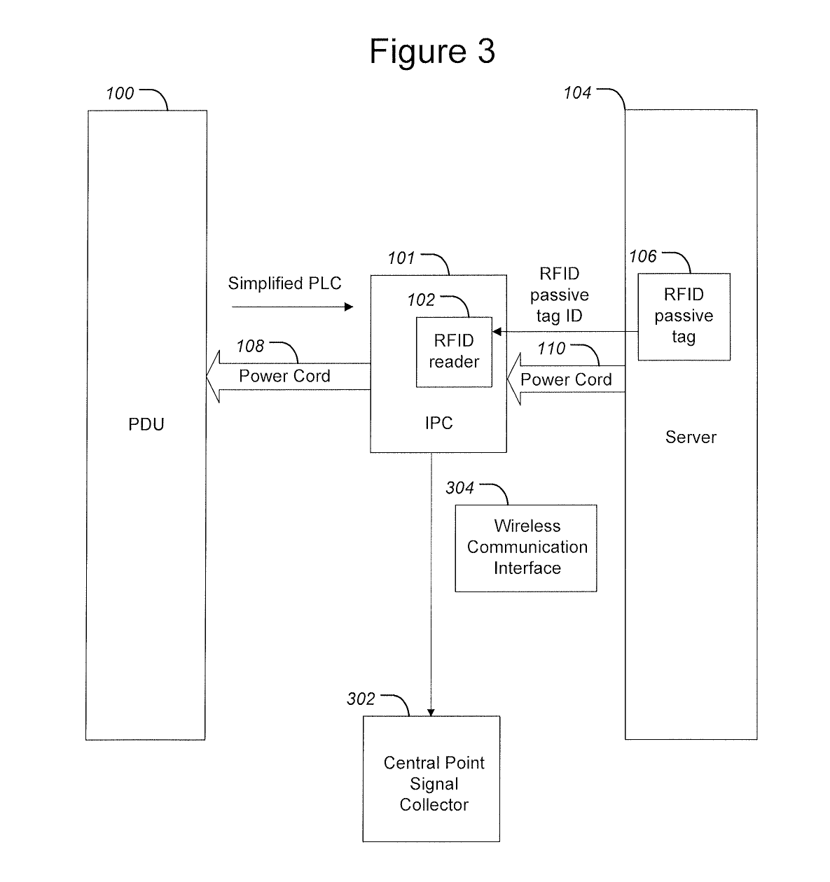

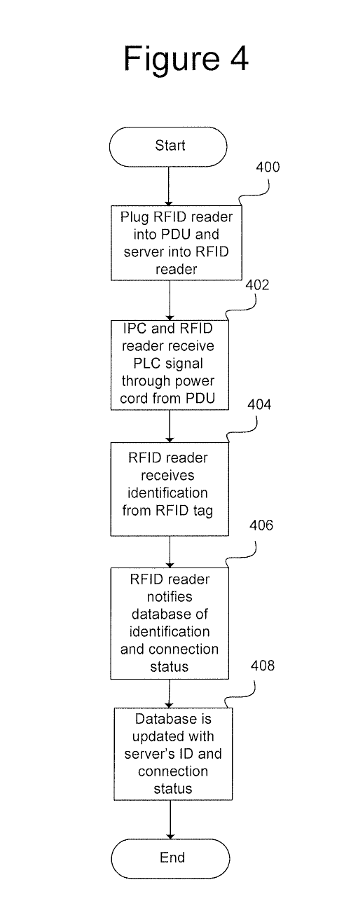

FIG. 3 depicts an exemplary PDU 100, an IPC 101, an RFID reader 102, server 104 and central point signal concentrator 302, in one implementation. FIG. 4 illustrates steps in an exemplary associated method in accordance with systems consistent with the present invention, and is discussed in conjunction with FIG. 3. In this implementation, the PDU 100 sends a request to IPC 101 including the RFID reader 102 for the identification of the attached IT component, i.e., server 104. For example, the PDU 100 sends the request, e.g., for power outlet 7 of the PDU 100, and the RFID reader 102 responds with the identification information, i.e., the server 104 is connected. As opposed to the previously discussed implementation, the PDU 100 makes the request for the information, as opposed to the RFID reader 102 initiating the identification transmission without a request.

In this implementation, again, the IPC 101 including the RFID reader 102 is plugged into the PDU's power outlet, and the server's power plug 110 is plugged into power outlet on the IPC 101 (step 400). In this case, the system makes a request through the PDU 100 for the status of the PDU's outlets. The PDU 100 sends a software protocol signal requesting the identification of the server 104 attached to the power outlet of the IPC 101. The IPC 101 receives the signal from the PDU 100 via the power cord 108 using the protocol similar to PLC (step 402) and the RFID Reader 102 also receives the server's ID wirelessly from the RFID tag 106 on the server ID (step 404). The IPC 101 including the RFID reader 102 then sends the server ID wirelessly to a central point signal concentrator 302 via the wireless communication interface 304 which may be any suitable device or component for sending wireless information (step 406). This wireless communication interface 304 may be attached to or part of the IPC 101. In another implementation, this communication may also be wired communication.

The wireless signal is passed to the central point signal concentrator 302, which may be a concentrator that collects many signals from many different RFID readers. The central point signal concentrator may include a large antenna that receives the information from various RFID readers in IPC's throughout the system. This central point signal concentrator 302 processes the received signals and sends them to a software layer (not shown). The software layer further processes the signals and sends them to the database, which updates accordingly. The central point signal concentrator may be used to send the IT component information request back to the original requestor.

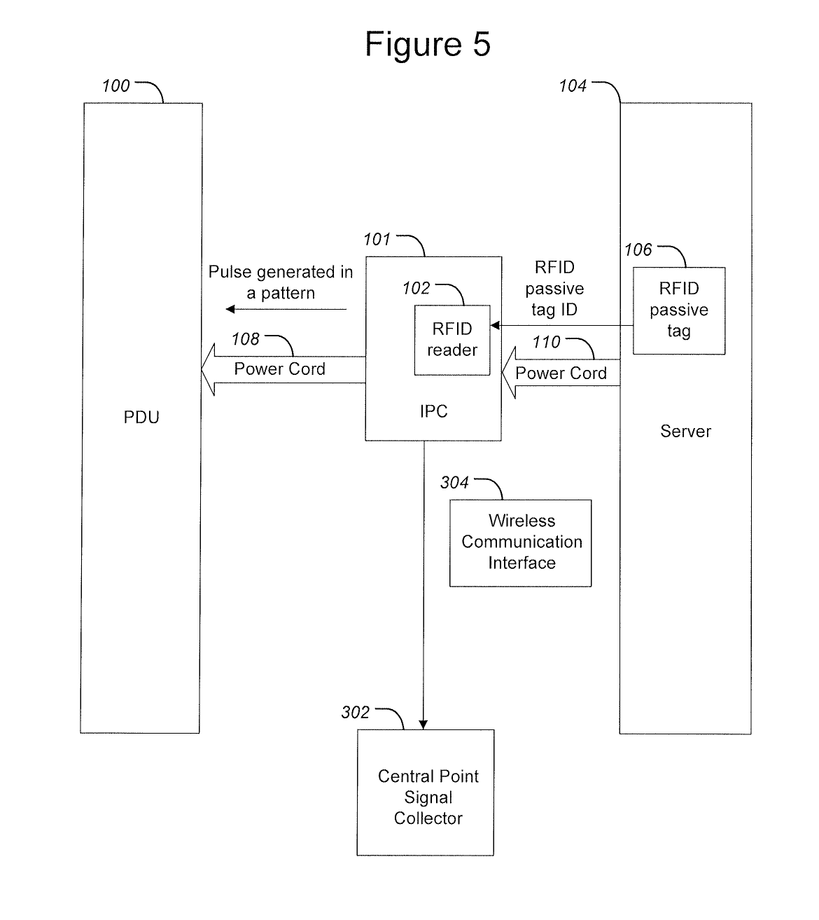

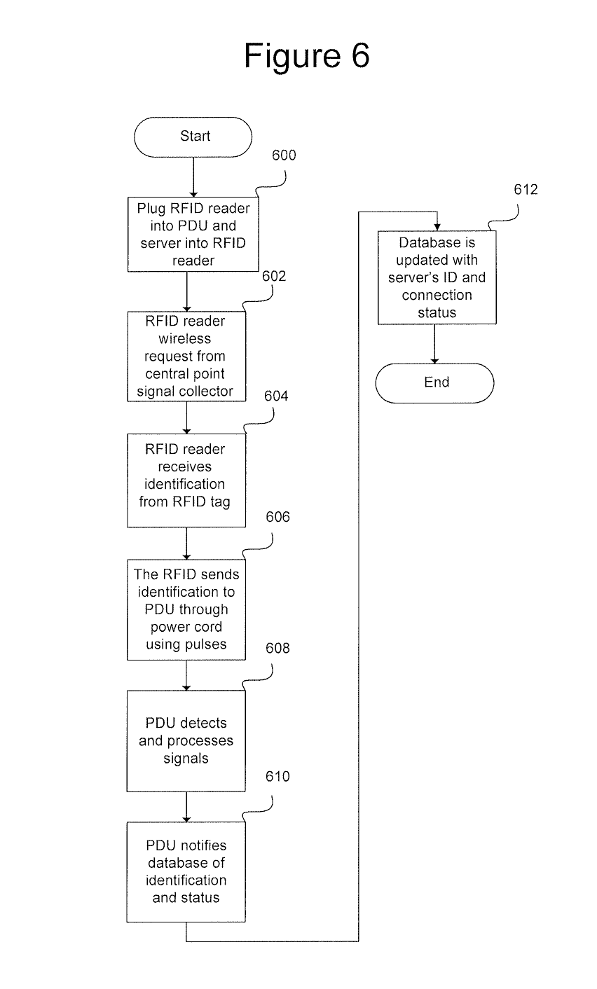

FIG. 5 depicts an exemplary PDU 100 and a central point signal concentrator 302 signaling a request to an IPC 101 including an RFID reader 102. FIG. 6 illustrates steps in an exemplary associated method in accordance with systems consistent with the present invention, and is discussed in conjunction with FIG. 5. Again, the IPC 101 plugs into the PDU 100 and the server 104 plugs into the IPC 101 (step 600). However, in this implementation, the signals between the RFID reader 102 and the PDU 100 are hardware signals, e.g., pulses on the power cord 108. Here, the software communication over the power line 108 is replaced with hardware communication over the power line, such as load modulation. This embodiment may be used to correlate a PDU 100 to a particular RFID reader 102. These embodiments are calibrated to avoid interference and the addition of noise on the power line 108 that may affect the target IT component.

In this implementation, the IPC 101 receives from the central point signal concentrator 302 a wireless signal requesting a server's ID (step 602). The MD reader 102 also receives the identification of the server 104 from its associated RFID tag 106 (step 604). In this implementation, the IPC 101 generates pulses on the power cord 108 in a given pattern to indicate to the PDU 100 the server's identification (step 606). The PDU 100 then detects the pulses and identifies which outlet received those pulses (step 608). The PDU 100 notifies the database (step 610), and the database updates accordingly (step 612).

In various alternatives, it is also possible to have a basic PDU and a more intelligent IPC 101 that has switching and metering capabilities built in. The foregoing description of preferred embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A method in a data processing system for automatically tracking associations of power outlets to IT components, comprising:
connecting one or more IT components to one or more power outlets;
automatically identifying the one or more IT components connected to the one or more power outlets; and
automatically identifying when one or more of the IT components are disconnected from one or more of the power outlets.

2. The method of claim 1, further comprising:
automatically providing the identification of the one or more connected IT components to a database; and
automatically updating the database upon receipt of the identification.

3. The method of claim 2, further comprising:
automatically providing the identification of the one or more disconnected IT components to the database; and
automatically updating the database upon receipt of the identification of the one or more disconnected IT components.

4. The method of claim 1, wherein each of the one or more IT components further comprise an RFID tag uniquely identifying the IT component, and wherein the method further comprises automatically identifying the one or more IT components by receiving the identification of the IT component from the associated RFID tag.

5. The method of claim 4, wherein an RFID reader performs the receiving the identification of the IT component from the associated RFID tag.

6. The method of claim 5, further comprising:
plugging the a device comprising RFID reader into a PDU; and
plugging the IT component into the device comprising the RFID reader.

7. The method of claim 1, further comprising sending the identification of the one or more connected IT components to a database wirelessly.

8. The method of claim 1, further comprising sending the identification of the one or more connected IT components on a power line to a PDU.

9. The method of claim 8, further comprising send the identification to the PDU using a software protocol on the power line.

10. The method of claim 8, further comprising send the identification of the one or more connected IT components to the PDU by generating pulses on the power line.

11. The method of claim 1, wherein the IT component is one of: (1) a server, (2) a router, and (3) a switch.

12. A method in a data processing system for automatically tracking associations of power outlets to IT components;
connecting one or more IT components to one or more power outlets; and
automatically identifying the one or more IT components connected to the one or more power outlets.

13. The method of claim 12, further comprising automatically sending the identification to a database.

14. The method of claim 13, further comprising automatically updating the database upon receipt of the identification.

15. A power plug device in a data processing system for automatically tracking associations of power outlets to IT components, comprising:
a power plug configured to plug into the power outlet of a PDU;
a power outlet configured to accept a power plug from an IT component having an associated RFID tag uniquely identifying the IT component; and
an RFID reader configured to receive an indication of an identification of the IT component from the RFID tag; and
a processor configured to transmit the received identification.

16. The device of claim 15, further comprising a wireless communication interface configured to wirelessly transmit the identification to a signal concentrator configured to relay the transmitted identification to a database.

17. A data processing system for automatically tracking associations of power outlets to IT components, comprising:
an IT component comprising an RFID tag configured to uniquely identify the IT component;
a power plug device comprising:
a power plug configured to plug into the power outlet of a PDU;
a power outlet configured to accept a power plug from the IT component;
an RFID reader configured to receive an indication of an identification of the IT component from the RFID tag; and
a processor configured to transmit the identification; and
a PDU comprising at least one power outlet configured to accept the power plug from the power plug device.

18. The data processing system of claim 15, further including a database configured to track one or more IT components connected to the PDU.

19. The data processing system of claim 18, further including a signal concentrator configured to receive the transmitted identification from the power plug device, and to send the transmitted identification to the database.
